(19) United States
(12) Patent Application Publication
(10) Pub. No.: US 2026/0010843 A1
(43) Pub. Date: Jan. 8, 2026

(54) SYSTEMS AND METHODS FOR MANAGING DISTRIBUTED RESOURCES

(71) Applicant: Capital One Services, LLC, McLean, VA (US)

(72) Inventors: Galen Rafferty, Mahomet, IL (US); Samuel Sharpe, Cambridge, MA (US); Justin Au-Yeung, Alexandria, VA (US)

(21) Appl. No.: 18/762,413

(22) Filed: Jul. 2, 2024

(51) Int. Cl. G06Q 10/0631; G06N 20/00

(52) U.S. Cl. CPC G06Q 10/06311; G06N 20/00

(57) ABSTRACT

Disclosed embodiments may include a method for managing distributed resources by receiving meeting data regarding a meeting and user data. The system may calculate, using content analysis by a first machine learning model, a meeting score, from the meeting data. Furthermore, the system may determine whether the meeting score is greater than or equal to a meeting threshold score. If the meeting score is greater than or equal to the meeting threshold score, the system may generate a message recommending that the meeting be canceled and transmit the message to a meeting organizer. The system may receive a signal from the meeting organizer indicating whether the meeting is canceled and train the first machine learning model using the signal from the meeting organizer.

### FIELD

The disclosed technology relates to systems and methods for managing distributed resources. Specifically, this disclosed technology relates to managing distributed computing resources or personnel resources for a more efficient use of time and energy.

### BACKGROUND

As organizations increase in size, operations generally require the use of an assortment of resources. As such, managing large amounts of resources effectively can become tedious. If large amounts of resources are handled unproductively or ineffectively, then inefficiencies can rise, increasing costs, wasting time, and requiring additional personnel. Furthermore, sometimes it can be difficult to tell whether an activity is going to be an inefficient use of time or resources until after that activity occurs. For example, for personnel attending a meeting, is it difficult to tell whether a meeting is an inefficient use of time prior to attending the meeting. However, frequently after a meeting personnel may realize that meetings were not an efficient use of time (e.g., if other personnel were not adequately prepared, or were too busy, etc.).

Accordingly, there is a need for improved systems and methods for managing distributed resources by recognizing traits associated with inefficient activities prior to the activity occurring and, in response, correcting or changing the activity in advance so time and resources may be more efficiently used. Embodiments of the present disclosure are directed to this and other considerations.

### SUMMARY

Disclosed embodiments may include a system for managing distributed resources. The system may include one or more processors, and memory in communication with the one or more processors and storing instructions that, when executed by the one or more processors, are configured to cause the system to provide a distributed computing system management tool. The system may receive, from a plurality of distributed computing devices, first data associated with the plurality of distributed computing devices indicating work performed associated with a first work request. The system may also calculate, using a first machine learning model, a score associated with the first work request based on the first data. Furthermore, the system may determine whether the score is greater than or equal to a threshold score representing work to be performed. In response to determining that the score is greater than or equal to the threshold score, the system may generate a first message canceling the first work request and transmit the first message to at least one distributed computing device of the plurality of distributed computing devices.

Disclosed embodiments may include a system for managing distributed resources by generating meeting recommendations. The system may include one or more processors, and memory in communication with the one or more processors and storing instructions that, when executed by the one or more processors, are configured to cause the system to generate meeting recommendations. The system may receive, from one or more user devices associated with one or more users, meeting data regarding a meeting and user data, wherein one of the users is a meeting organizer. The system may also calculate, using content analysis by a first machine learning model, a meeting score, from the meeting data. Furthermore, the system may determine whether the meeting score is greater than or equal to a meeting threshold score. In response to determining that the meeting score is greater than or equal to the meeting threshold score, the system may generate a message recommending the meeting be canceled, transmit the message to the meeting organizer, receive a signal from the meeting organizer indicating whether the meeting is canceled, and train the first machine learning model using the signal from the meeting organizer.

Disclosed embodiments may include a system for managing distributed resources by generating meeting recommendations. The system may include one or more processors, and memory in communication with the one or more processors and storing instructions that, when executed by the one or more processors, are configured to cause the system to generate meeting recommendations. The system may receive, from one or more user devices associated with one or more users, meeting data regarding a meeting and user data, wherein one of the users is a meeting organizer. The system may also calculate, using content analysis by a first machine learning model, a meeting score, from the meeting data. Additionally, the system may determine whether the meeting score is greater than or equal to a meeting threshold score. In response to determining that the meeting score is greater than or equal to the meeting threshold score, the system may generate a first graphical user interface for polling the one or more users regarding whether the meeting should be held, transmit the first graphical user interface to the one or more user devices for display, receive results from the one or more user devices regarding whether the meeting should be held, and determine whether the meeting should be held based on an organizational policy. In response to determining that the meeting should be held, the system may generate a second graphical user interface notifying the one or more users that the meeting will be held and transmit the second graphical user interface to the one or more user devices for display. In response to determining that the meeting should not be held, the system may generate a third graphical user interface notifying the one or more users that the meeting will not be held and transmit the third graphical user interface to the one or more user devices for display.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for managing distributed resources in accordance with certain embodiments of the disclosed technology.

FIG. 2A is a flow diagram illustrating an exemplary method for managing distributed resources by generating meeting recommendations in accordance with certain embodiments of the disclosed technology.

FIG. 2B is a flow diagram illustrating an exemplary method for managing distributed resources by generating meeting recommendations in accordance with certain embodiments of the disclosed technology.

FIG. 3 is a block diagram of an example resource management system used to provide managing distributed resources, according to an example implementation of the disclosed technology.

FIG. 4 is a block diagram of an example system that may be used to manage distributed resources, according to an example implementation of the disclosed technology.

### DETAILED DESCRIPTION

The disclosed technology may include a distributed computing system management tool that receives data from a plurality of devices regarding work performed or associated with a work request. The system may then calculate a score regarding the work request, representing the work to be performed, and compare it relative to a threshold score, which may allow the system to recognize inefficiencies preemptively. The system may perform an action based on the score being higher or lower than the threshold score. In some embodiments, the system may cancel the work request based on the existing demand on resources and determining the existing work product is sufficient. In some embodiments, such as those where the system reviews scheduled meetings for potential inefficiencies, the system may determine a meeting should be canceled and whether the information regarding the meeting may be distributed to the participants in a summarized format (e.g., an email). In other embodiments, the system may determine the best scheduling time for a meeting for users using similar means.

Examples of the present disclosure related to systems and methods for managing distributed resources. More particularly, the disclosed technology relates to efficiently organizing resources to be utilized to their most efficient potential by eliminating downtime and tasks that are repetitive or insignificant. The systems and methods described herein utilize, in some instances, machine learning models, which are necessarily rooted in computers and technology. Machine learning models are a unique computer technology that involves training models to complete tasks and make decisions. The present disclosure details training a model to generate a score based on data received from computing devices. This, in some examples, may involve using input data, applying content analysis, and using machine learning models to output a score. The score may be compared to a threshold score, which may be representative of the need of the work request or the competing demands for resources. The system may also train the machine learning models using feedback obtained from the computing devices. Using a machine learning model in this way may allow the system to increase efficiency of computing or personnel resources. Furthermore, examples of the present disclosure may also improve the speed with which computers can perform tasks by determining the relative importance of tasks and canceling or rescheduling unnecessary or repetitive tasks. Overall, the systems and methods disclosed have significant practical applications in managing distributed resources because of the noteworthy improvements of utilizing a machine learning model in this way, which are important to solving present problems with this technology.

The systems and methods described herein also utilize, in some instances, graphical user interfaces, which are necessarily rooted in computers and technology. Graphical user interfaces are a computer technology that allows for user interaction with computers through touch, pointing devices, or other means. The present disclosure details interacting with a user via a user device to receive indications from a user on whether an event should occur. This, in some examples, may involve receiving votes from a plurality of user devices in order and generating a dynamically changing graphical user interface that displays the votes and indicates if an event should occur. Overall, the systems and methods disclosed have significant practical applications in making meetings and events more efficient by determining, through the input of users via the graphical user interface and via input data, if the meeting is essential or expendable, which is a current unmet need with other similar technologies.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

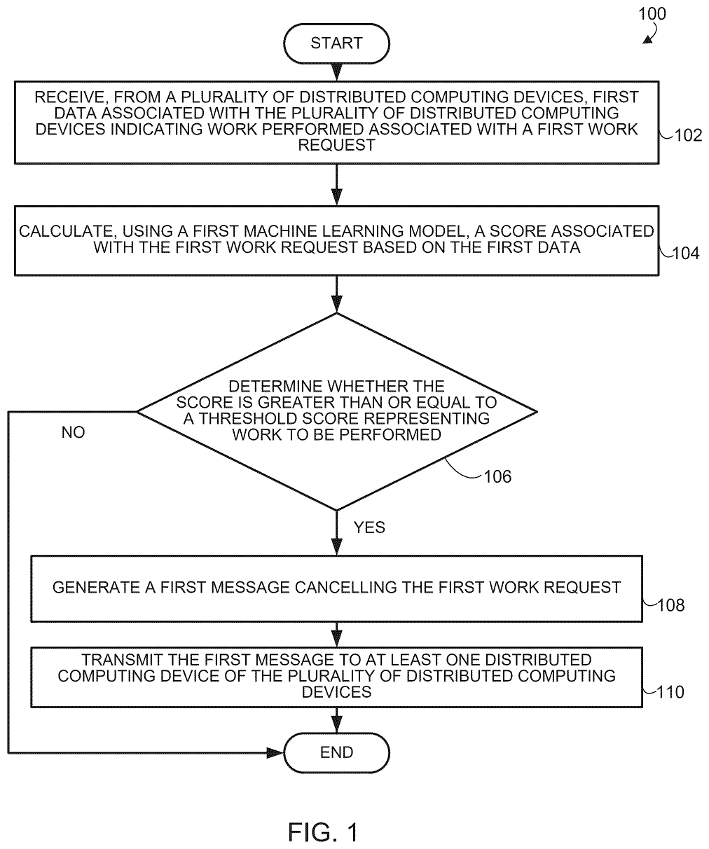

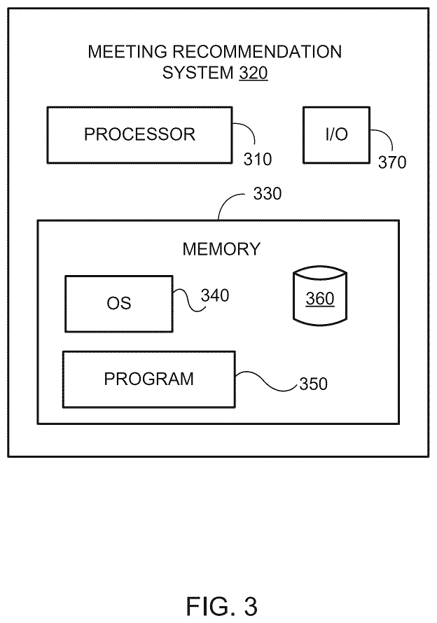

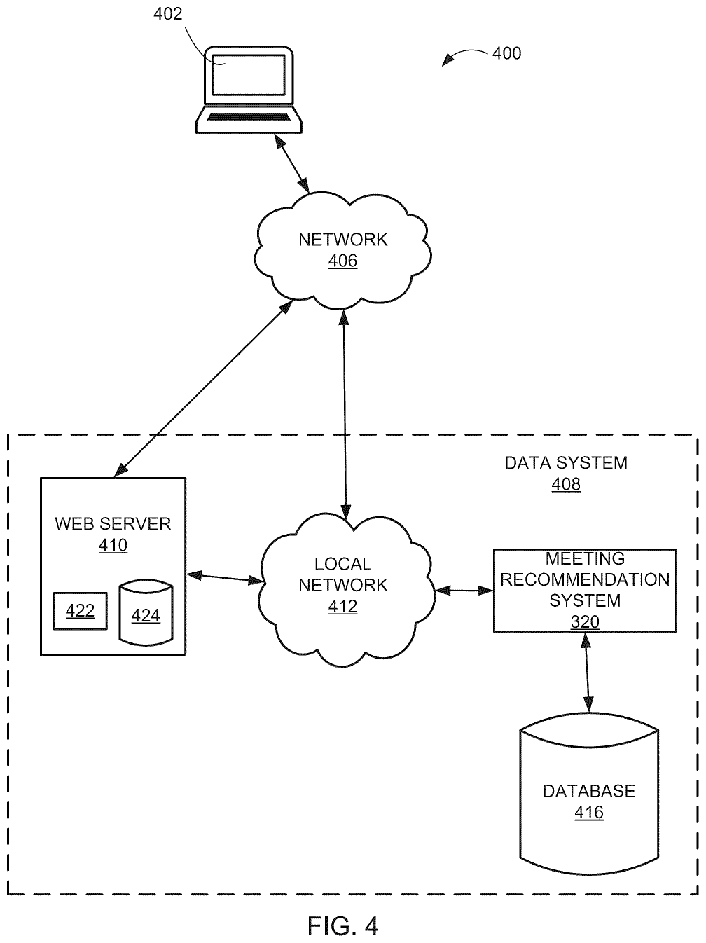

FIG. 1 is a flow diagram illustrating an exemplary method 100 for managing distributed resources, in accordance with certain embodiments of the disclosed technology. The steps of method 100 may be performed by one or more components of the system 400 (e.g., resource management system 320 or web server 410 of data system 408 or user device 402), as described in more detail with respect to FIGS. 3 and 4.

In block 102, the resource management system 320 may receive, from a plurality of distributed computing devices, first data associated with the plurality of distributed computing devices indicating work performed associated with a first work request. The resource management system 320 may receive a first work request directly or indirectly. The resource management system 320 may receive first data indicating a number and type of distributed computing devices, with associated throughputs. A plurality of distributed computing devices may report and provide data to resource management system 320. The resource management system 320 may receive data regarding the completion of a first work request or further work requests.

In block 104, the resource management system 320 may calculate, using a first machine learning model, a score associated with the first work request based on the first data. The resource management system 320 may consider a number of factors when calculating the score associated with the work request. One portion of the score may be a result of content analysis of the work request. To complete the content analysis, the resource management system 320 may utilize a machine learning model. The machine learning model may be a natural language processing model. The resource management system 320 may analyze all information about a work request using organization data (e.g., data regarding the organization that may aid in determining the impact of the work request) or worker data (e.g., data regarding the availability or busyness of the plurality of distributed computing devices). The machine learning model may determine a score for each work request item. Work request items that appear repetitive or unimportant may cause the score to rise.

The machine learning model, which may also be one or more machine learning models, may be configured to aggregate and output a work request score. The machine learning model may determine a score for all items within a work request. The overall score of the work request may be an average of the scores of different work request items. The scores of the different work request items may be weighted depending on the amount of time devoted to the work request item (out of the amount of time for the work request overall). Alternatively, the scores of the different work request items may be weighted by rated importance (if the work request items are given importance ratings from the work request data). The machine learning model may be trained using information that is organization specific. Alternatively, the machine learning model may be trained using information from a variety of organizations. The machine learning model may be trained by a specific set of training data. The resource management system 320 may iteratively determine and redetermine work request scores and alternative work request scores as details regarding the work request or distributed computing devices change (e.g., number of devices).

The machine learning model may have a feedback mechanism (or feedback loop) for training purposes. In some embodiments, the resource management system 320 may use a second machine learning model to compare the score to other work to be performed.

In block 106, the resource management system 320 may determine whether the work request score is greater than or equal to a threshold score representing work to be performed. The resource management system 320 may compare the work request score determined in block 104 to a threshold work request score. The threshold work request score may be a maximum score for a work request. The threshold work request score may be static or dynamic. The threshold work request score may be set by the organization. A work request score above the threshold work request score may indicate that the work request is unnecessary, not urgently necessarily or the resources could be better used elsewhere. The threshold work request score may be based on an existing demand on resources. A work request score below the work request threshold score may indicate that the work request is necessary and should take place. If the work request score is less than the work request threshold score, the method may end. If the work request score is greater than or equal to the threshold work request score, the method may continue to block 208. In alternative embodiments, the resource management system 320 may also configure work request scores in other ways (e.g., such as having a work request score at a default level, where the work request score is decreased for assorted reasons, and the work request score needs to be above a threshold work request score, rather than below). The resource management system 320 may also determine whether one or more alternative work request scores are above the threshold work request score. In some embodiments, determining that the work request score is greater than or equal to the work request threshold score may comprise determining whether the existing work product (e.g., the subject of the work request) is sufficient.

In block 108, the resource management system 320 may generate a first message canceling the first work request. In response to determining the work request score is greater than the threshold work request score, the resource management system 320 may generate a first message canceling the first work request. The message may indicate that the first work request is to be rescheduled.

In block 110, the resource management system 320 may transmit the first message to at least one distributed computing device of the plurality of distributed computing devices. In response to receiving the first message canceling the first work request, one or more distributed computing devices may accept or refuse the cancellation of the work request. The distributed computing devices may respond to resource management system 320 with an additional message indicating the acceptance or refusal of the first work request. The acceptance or refusal of the first work request by the plurality of distributed computing devices may be used to train the first machine learning model regarding future similar work requests.

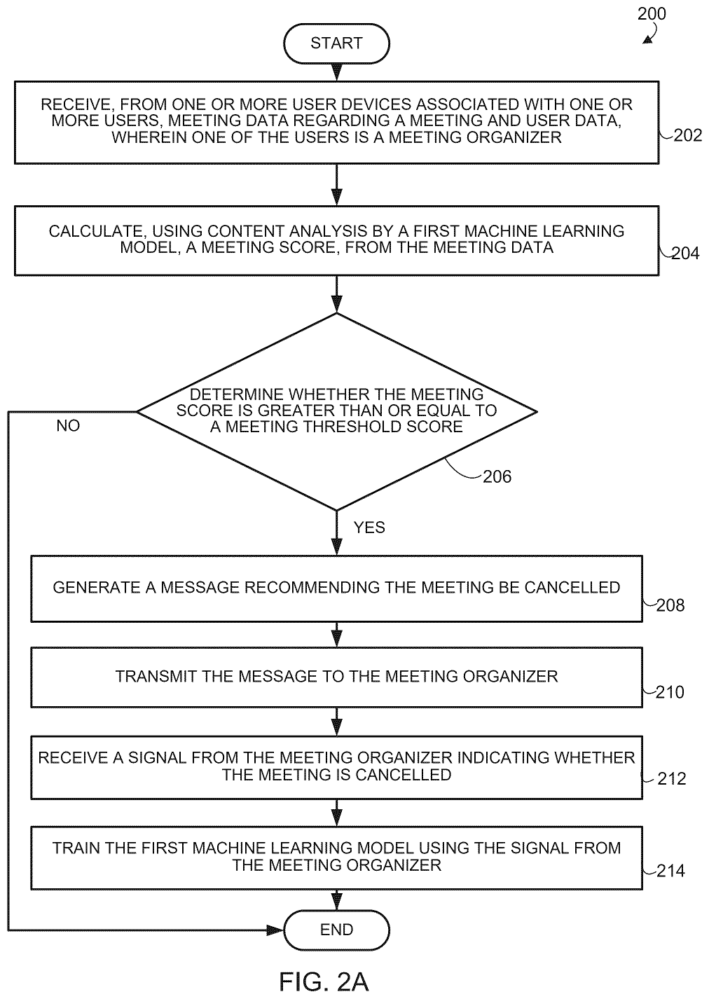

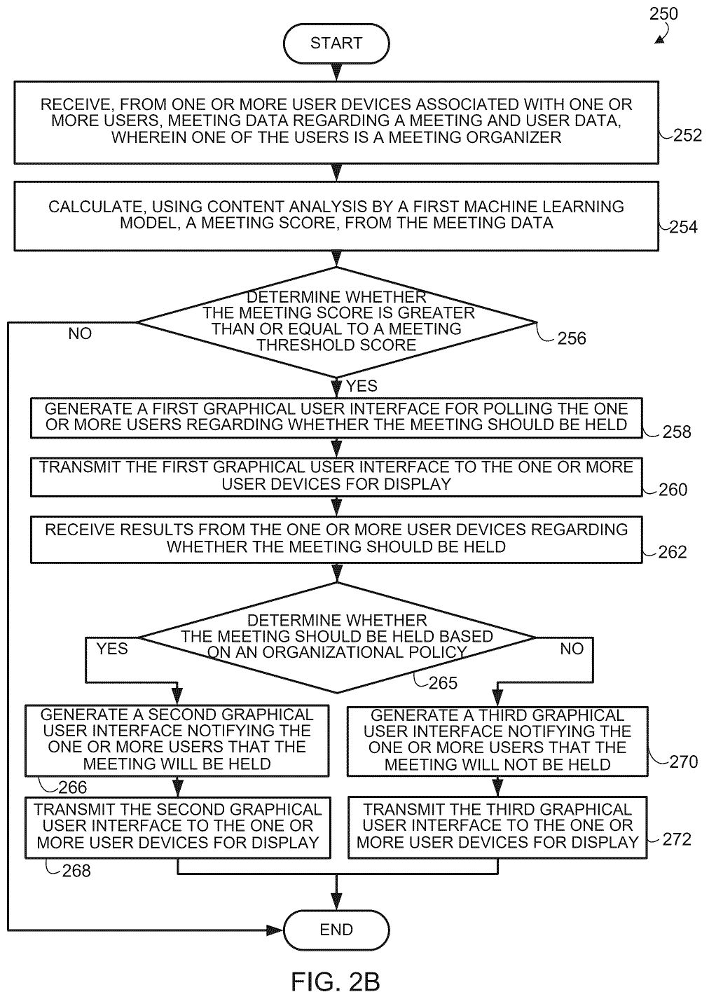

FIG. 2A is a flow diagram illustrating an exemplary method 200 for managing distributed resources, in accordance with certain embodiments of the disclosed technology. The steps of method 200 may be performed by one or more components of the system 400 (e.g., resource management system 320 or web server 410 of data system 408 or user device 402), as described in more detail with respect to FIGS. 3 and 4.

In block 202, the resource management system 320 may receive, from one or more user devices associated with one or more users, meeting data regarding a meeting and user data, wherein one of the users is a meeting organizer. The meeting data may indicate a time, location, and/or duration of a meeting. The meeting data may also include a title or indication of relative importance (e.g., indicating the meeting is an “emergency meeting”). The meeting data may include an agenda for the meeting with agenda items. The agenda may include an amount of time to spend on each agenda item. The agenda items may include a brief description of the agenda item and what is to be discussed. The agenda items may have an indication of importance. The meeting data may include a list of one or more participants (which may be coordinated to users, user devices, or user accounts of resource management system 320) or one or more meeting organizers. In some embodiments, the meeting data may also include a mandatory indication (e.g., an indication that the meeting must occur, such as for a regulatory meeting, mandated training session, auditing call, or other urgent, necessary meeting). Selection of the mandatory indication may be limited to users of a specific organizational level. User data may include information about individual participants in the meetings. User data may include the user's schedule, available time, busy time, position in the organization (e.g., derived from an organization chart used as input), job title, business relationship to other participants in the meeting (and other known relationships), and location. User data may further include data surrounding the aforementioned relationships, such as a number of email exchanges, or other such numerical data that may be quantifiable and relevant to the user and/or the meeting. One of the meeting participants may be the meeting organizer, or the person who set up the meeting. The meeting organizer may be the leader of the meeting or a supervisor of the other users. In some embodiments, the resource management system 320 may generate and transmit a graphical user interface to request or receive the meeting data from the user device. The graphical user interface may be integrated into calendar or time management software (e.g., Microsoft® Outlook).

In block 204, the resource management system 320 may calculate, using content analysis, a meeting score, from the meeting data. The resource management system 320 may consider a number of factors when calculating the meeting score. One portion of the meeting score may be a result of content analysis of the agenda. To complete the content analysis, the resource management system 320 may utilize a machine learning model. The machine learning model may be a natural language processing model. The resource management system 320 may analyze all information about a meeting using the meeting data and/or the user data. The resource management system 320 may utilize the first machine learning model to analyze the agenda associated with the meeting provided within the meeting data. The resource management system 320 may utilize the machine learning model to analyze and determine the approximate meaning of the text of each agenda item. The machine learning model may determine or classify whether each agenda item on the agenda appears to be (1) informational or (2) requiring discussion or action. The machine learning model may determine a score for each agenda item. Agenda items that appear largely informational may cause the score to rise. Agenda items requiring discussion or action may cause the score to remain the same or lower.

One or more machine learning models, one of which may be the same machine learning model used to process the agenda language above, may be configured to aggregate and output a meeting score. The machine learning model may determine a score for the agenda or meeting data overall. The overall score of the agenda may be an average of the scores of different agenda items. The scores of the different agenda items may be weighted depending on the amount of time devoted to the agenda item (out of the amount of time in the meeting overall). Alternatively, the scores of the different agenda items may be weighted by rated importance (if the agenda items are given importance ratings from the meeting data). The machine learning model may be trained using information that is organization specific. Alternatively, the machine learning model may be trained using information from a variety of users from a variety of organizations. The machine learning model may be trained by a specific set of training data. The machine learning model may have a feedback mechanism (or feedback loop) and be able to learn from the response of one or more users (see block 214).

Additionally, the resource management system 320 may consider a number of additional factors. The resource management system 320 analyzes the meeting data to determine if background reading or materials are required for the meeting. If the background materials are required, the resource management system 320 may then determine if the background reading materials have been available for a sufficient amount of time prior to the meeting for participants to adequately review. If the reading materials have not been available or have not been available for a sufficient amount of time for review, then the score of the meeting may rise.

The resource management system 320 may analyze the calendars and schedules of the participants using the user data. For each user, the resource management system 320 may determine, from the user data, if the user's schedule appears to be abnormally busy around the time of the planned meeting. The resource management system 320 may determine if a user is abnormally busy by analyzing the user's schedule and determine whether the number of meetings and/or scheduled events around the time of the planned meeting is one or more standard deviations above normal. The resource management system 320 may consider if the user is out-of-the-office or on vacation. The user data may also be able to receive an input from a user indicating that the user is abnormally busy for a particular time frame. If more than a threshold percentage of users are determined by resource management system 320 to be abnormally busy around the planned meeting time, then the resource management system 320 may raise the meeting score.

The resource management system 320 may further analyze the agenda to determine if any participants or users are specifically named. These participants may be determined to be presenters. The resource management system 320 may compare the presenters to the meeting participants to determine how frequently they work together. The comparison may use the user data for each participant and presenter to determine if users are in common departments or divisions of an organization. The resource management system 320 may compare the department names of each user to determine if they are the same. The resource management system 320 may also have access to, or be able to receive data from, an organizational chart. The organizational chart may include departments, divisions, and ranks. The resource management system 320 may use the organization chart to determine a distance between meeting presenters or users (e.g., by measuring the number of positions in between each user).

Participants and presenters who work frequently together (e.g., who are part of the same department) may not need to have a meeting as frequently as participants and presenters who do not work frequently together (e.g., as part of a cross-department collaboration activity). Accordingly, meetings that have users with a certain degree of separation may be more important or more needed than meetings between colleagues that frequently work together. Therefore, meetings between people who meet frequently may cause resource management system 320 to raise the meeting score. In some embodiments, such as where an interdisciplinary team meeting is occurring, if the distance between meeting presenters or users on average is greater than a threshold distance, then the meeting score may remain unchanged; however, if the distance between meeting presenters or users on average is less than a threshold distance, the resource management system 320 may raise the meeting score. In some embodiments, such as where project team meeting is occurring, if the distance between meeting presenters or users on average is less than a threshold distance, then the meeting score may remain unchanged; however, if the distance between meeting presenters or users on average is greater than a threshold distance, the resource management system 320 may raise the meeting score.

In an alternative embodiment, the scores may be indicative of a holistic impression of the agenda as a whole (e.g., a meeting entitled “weekly update call” may be given a greater score than a meeting entitled “last-minute emergency meeting”).

As a result of step 204, the resource management system 320 assigns a score to the meeting, which is indicative of the overall relative importance or necessity of the meeting to occur at that time. In some embodiments, the resource management system 320 may generate an alternative meeting score for having the meeting at an alternative time or with alternative participants. The alternative meeting score may be calculated in the same manner as the meeting score but may be scored based on a different date or time for the meeting (e.g., if the meeting score is elevated because the participants are busy on that day, the meeting score is lower on a day that the participants are not busy). The resource management system 320 may generate a variety of alternative meeting scores for a variety of different times. The alternative meeting scores may also consider when users are on vacation or out-of-the-office. The resource management system 320 may iteratively determine and redetermine meeting scores and alternative meeting scores as details regarding the meeting or participants change.

In block 206, the resource management system 320 may determine whether the meeting score is greater than or equal to a threshold meeting score. The resource management system 320 may compare the meeting score determined in block 204 to a threshold meeting score. The threshold meeting score may be a maximum score for a meeting. The threshold meeting score may be static or dynamic. The threshold meeting score may be set by the organization (e.g., if the organization has visitors or a conference one day, the threshold meeting score for that particular day may be lower than normal for one or more departments). A meeting score above the threshold meeting score may indicate that the meeting is unnecessary or could be reduced to an informational email. A meeting score below the threshold meeting score may indicate that the meeting is necessary and should take place. If the meeting score is less than the threshold meeting score, the method may end. If the meeting score is greater than or equal to the threshold meeting score, the method may continue to block 208. In alternative embodiments, the resource management system 320 may also configure meeting scores in other ways (e.g., such as having a meeting score at a default level, where the meeting score is decreased for assorted reasons, and the meeting score needs to be above a threshold meeting score, rather than below). The resource management system 320 may also determine whether one or more alternative meeting scores are above the threshold meeting score. In some embodiments, the selection of a mandatory indication may allow the meeting without recommending cancellation even if the meeting score is above the threshold meeting score.

In some embodiments, the threshold meeting score may be derived from organizational resource limitations or costs. The resource management system 320 may determine a cost associated with personnel at a meeting (e.g., by looking at the salaries and/or costs of individual employees and determining their cost to attend the meeting versus the value derived from the employee attending the meeting), a cost associated with a meeting room reservation (e.g., costs of renting a room if needed, travel costs, virtual meeting costs, costs of preventing other meetings if meeting rooms are in low supply), and a cost associated with technology resources needed (e.g., presentation materials). An increase in cost over a threshold determined cost at an organizational or departmental level may decrease the threshold meeting score.

In block 208, the resource management system 320 may generate a message recommending the meeting be canceled. Because in block 206, the resource management system 320 determined, based on comparing the meeting score to the threshold meeting score, that the meeting was not necessarily or did not reach a certain level of importance, the resource management system 320 may generate a message indicating that the meeting should be canceled. The resource management system 320 may generate the message indicating that the meeting should be canceled as part of dynamic interactive graphical user interface. In some embodiments, the resource management system 320 may cancel the meeting without asking the meeting organizer. In some embodiments, the message may indicate a breakdown of the meeting score, the reasons for the meeting score, and a comparison to the threshold meeting score to aid users or meeting organizers in having a more productive meeting. The option to display the meeting score and other information in the message may be made at an organization, department, user, or specific meeting level. In some embodiments, the message may not show the meeting score or may obscure the meeting score or other details about the meeting (e.g., threshold meeting score) to meeting organizers. In some embodiments, the meeting scores or other information may be not shown or obscured below a threshold organizational level to prevent meeting organizers from attempting to circumvent a meeting cancellation or receiving recommendation the meeting be canceled.

In block 210, the resource management system 320 may transmit the message to the meeting organizer. The resource management system 320 may transmit the message as part of the dynamic interactive graphical user interface. In some embodiments, the message may be sent to the meeting organizer via email. In other embodiments, the message may be integrated into the meeting organizer's calendar or time management software (e.g., Microsoft® Outlook). The message may show on the meeting organizer's calendar as a notification or highlight the specific meeting that the message is about.

In block 212, the resource management system 320 may receive a signal from the meeting organizer indicating whether the meeting is canceled. Based on receiving the message in block 210, the meeting organizer may have a variety of options regarding the meeting. The graphical user interface presenting the message may present the meeting organizer with an option to continue with the meeting (e.g., an override option). This allows the meeting organizer to decide to have the meeting despite the meeting score being higher than the threshold meeting score. The graphical user interface may also present the meeting organizer with an option to cancel the meeting. A notification of the canceled meeting may be sent to the participants. The resource management system 320 may, in some embodiments, generate a summary of the meeting based on the meeting materials to include with the notification of the canceled meeting. The graphical user interface may also present the meeting organizer with an option to reschedule the meeting or schedule the meeting at a more convenient time for users (e.g., based on the busyness consideration for users discussed with respect to block 204). The graphical user interface of the resource management system 320 may present the meeting organizer with suggest alternative meeting dates based on the alternate meeting scores (e.g., the iteratively generated meeting scores). The graphical user interface may present a calendar listing the alternative meeting scores of the meeting on a variety of different days. The graphical user interface may highlight certain days where the alternative meeting score is the most favorable (e.g., the meeting score is the lowest) or where the alternative meeting score is less than the threshold meeting score. In some embodiments, the resource management system may track a meeting organizer's use of the override option in order to provide information or determine if specific meeting organizers were circumventing recommendations regarding canceling meetings.

In block 214, the resource management system 320 may train the first machine learning model using the signal from the meeting organizer. If the signal from the meeting organizer indicates that the meeting organizer decided to continue with the meeting, the first machine learning model can use that as feedback to adjust individual scores for individual portions of the meeting score (e.g., if the reading material had been distributed early enough). If the signal from the meeting organizer indicates that the meeting organizer decided to cancel the meeting, the first machine learning model may use that as feedback reinforcing the values for the individual score changes. If the signal from the meeting organizer indicates that the meeting organizer is rescheduling the meeting, the first machine learning model may use the information to reinforce certain meeting traits, in particular those related to the time of the meeting (e.g., if the reading material had not been distributed early enough or the participants were too busy at that time). Over time the first machine learning model may use the training data provided in block 214 to establish long-term trends (e.g., Meeting X on the first Tuesday of each month is never canceled). In some embodiments, the resource management system 320 may be able to recommend meetings proactively (e.g., as the resource management system 320 is trained on organization or team-specific data) such that resource management system 320 may be able to recommend the best times for meetings based on the participants and agenda to the meeting organizer, and provide the meeting organizer with an assortment of meeting options that have the best meeting scores (or are above the meeting threshold score). Then the meeting organizer may choose the best option for the meeting based on the assortment of meeting options with the threshold scores.

In some embodiments, the resource management system 320 may be configured to transmit a request for an evaluation of the meeting to one or more user devices associated with one or more users (or attendees) of the meeting. The resource management system 320 may send the evaluation prior to the meeting starting (e.g., similar to a poll, where the users may vote if they believe the meeting should take place) or after the meeting ends (e.g., where the users may reflect if the meeting was necessary). The request for the evaluation may be in the form of a dynamic interactive graphical user interface. Users may be able to interact with the graphical user interface of resource management system 320 to submit a response to the request. The resource management system 320 may receive a response comprising an evaluation of the meeting from the one or more user devices. The user responses to the evaluation of the meeting may be used to change the threshold meeting score, and, therefore, may have an impact on future meeting scores.

In some embodiments, the resource management system 320 may be configured to generate user scores for each user invited to the meeting. The resource management system 320 may generate, using content analysis, a first user score for a first user, from the user data and the meeting data. The resource management system 320 may utilize a machine learning model, which may be similar to the machine learning models referred to above, to generate the user score. The first user score may represent an individual need or ability of a user to attend a meeting. For example, if a user is busy around the time of the meeting, the individual user score may increase. Each user may have a user score threshold associated with that particular user. The user score threshold may be set by a user or may be assigned to a user based on organizational rank or by situation. For example, a user of a higher hierarchical position within an organization may have a lower user score threshold, because they would rather receive summaries of meetings rather than attending the meeting. In calculating the first user score and the first user score threshold, the resource management system 320 may use similar methods and strategies as determining the meeting score and meeting score threshold. If a user is invited to a meeting, and their first user score is greater than the first user threshold score, then the resource management system 320 may cancel the meeting for the first user. The resource management system 320 may cancel the meeting automatically or may cancel the meeting after prompting the user. In response to canceling the meeting for the first user, the resource management system 320 may recalculate the meeting score for the remaining attendees. The resource management system 320 may generate a summary of a meeting from the meeting data and transmit the summary of the meeting to the first user. The resource management system 320 may generate a user score for every user attending a meeting. User scores may also be derived and/or impacted by organizational resource limitations or costs.

FIG. 2B is a flow diagram illustrating an exemplary method 250 for managing distributed resources, in accordance with certain embodiments of the disclosed technology. The steps of method 250 may be performed by one or more components of the system 400 (e.g., resource management system 320 or web server 410 of data system 408 or user device 402), as described in more detail with respect to FIGS. 3 and 4.

Method 250 of FIG. 2B is similar to method 200 of FIG. 2A. The descriptions of blocks 252, 254, and 256 in method 250 are similar to the respective descriptions of blocks 202, 204, and 206 of method 200 and are not repeated herein for brevity. However, blocks 258, 260, 262 are different from blocks 208, 210, and 212 and are described below. Additional blocks 265, 266, 268, 270, and 272 are also described below. In some embodiments, aspects of method 250 may be combined with aspects of method 200.

In block 258, the resource management system 320 may generate a first graphical user interface for polling the one or more users regarding whether the meeting should be held. In response to determining that the meeting score is greater than the threshold meeting score in block 256 (which may be generally similar as described to determining the meeting score as in block 206), the resource management system 320 may effectively determine that the meeting may not be an optimized use of time. Therefore, the resource management system 320 may generate a dynamic, interactive graphical user interface for polling the one or more users. The graphical user interface may poll the one or more users with questions to determine whether the meeting should be held. The questions may be simplistic (e.g., “could this meeting be replaced with an update email to all colleagues?”) or complex with multiple questions (e.g., “could you please select a necessary item for discussion at the meeting?”). The graphical user interface may include drop-down boxes with selection items from the meeting agenda or a catch-all category box. In some embodiments, the graphical user interface may present a vote whether each user may vote whether the meeting should be held.

In block 260, the resource management system 320 may transmit the first graphical user interface to the one or more user devices for display. The resource management system 320 may transmit the message as part of the dynamic interactive graphical user interface. In some embodiments, the message may be sent to all of the users via email, or a selected number of users. In other embodiments, the message may be integrated into the user's calendar or time management software (e.g., Microsoft® Outlook). The message may show on the user's calendar as a notification or highlight the specific meeting that the message is about.

In block 262, the resource management system 320 may receive results from the one or more user devices regarding whether the meeting should be held. The results may represent the user's/future meeting participant's thoughts regarding the meeting. This may include receiving results from the graphical user interface regarding the polling. This may include simplistic votes (e.g., “yes” or “no”) or more complex responses (e.g., “we have to discuss matter X”). The results may be used as feedback to the machine learning model for calculating the meeting score for block 254, similar to as described with reference to block 214.

In block 265, the resource management system 320 may determine whether the meeting should be held based on an organizational policy. The resource management system 320 may utilize the results from the polling to determine if the meeting should be held. This may involve the use of an organizational policy. An organization policy may be a predetermined or pre-setup series of rules that determines whether a meeting should be held based on the results to the polling question. Examples of organizational policy may include: if a majority of the participants vote for the meeting to occur, then proceeding with the meeting; if a quorum of participants vote for the meeting to occur, then proceeding with the meeting; if a single participant indicates that a item must be discussed, then proceeding with the meeting; if a participant of a certain level (based on the organizational chart) indicates that an item must be discussed, then proceeding with the meeting; and if a majority or quorum of participants of a certain level (based on the organizational chart) indicate that the meeting must occur, then proceeding with the meeting. The organizational policy may be specific to a certain group or department within an organization. The organizational policy may be able to be overridden by the meeting organizer, or a participant with sufficient seniority (based on the organizational chart). The organizational policy may be based on allowing the meeting if a majority of the items in the meeting need to be discussed. Based on the results, if the resource management system 320 determines that the meeting should be held based on the organizational policy, the method may proceed to block 266. If the resource management system 320 determines that the meeting should not be held based on the organization policy, the method may proceed to block 270. The results and/or the determination for the meeting to occur or not occur may be used as feedback to the machine learning model for calculating the meeting score for block 254, similar to as described with reference to block 214. In some embodiments, the outcome of the poll may be used to train the first machine learning model (e.g., the majority decision of the users, or the decision of the meeting organizer).

In block 266, the resource management system 320 may generate a second graphical user interface notifying the one or more users that the meeting will be held. In response to the resource management system 320 determining that the meeting should be held, the resource management system 320 may generate a second graphical user interface indicating to the one or more users/future meeting participants that the meeting will be held or confirming the meeting. The second graphical user interface may allow for feedback from the user regarding the meeting score, or the decision to hold the meeting based on organization policy.

In block 268, the resource management system 320 may transmit the second graphical user interface to the one or more user devices for display. The second graphical user interface may be generally similar to the graphical user interface described in block 260 and may be an email or part of a calendar or time management software.

In block 270, the resource management system 320 may generate a third graphical user interface notifying the one or more users that the meeting will not be held. In response to the resource management system 320 determining that the meeting should not be held, the resource management system 320 may generate a third graphical user interface indicating to the one or more users/future meeting participants that the meeting will not be held. The third graphical user interface may allow for feedback from the user regarding the meeting score, or the decision to hold the meeting based on organization policy. The third graphical user interface may also present a summary of what the meeting was proposed to cover. In some embodiments, the third graphical user interface presented to the meeting organizer may be unique and may present options for the meeting organizer to reschedule the meeting at a different date or time. The third graphical user interface may also present options for the meeting organizer and/or participants to comment on the items to be addressed in the meeting (e.g., if the reading materials for the meeting were provided without context or commentary, the third graphical user interface may present an option for the meeting organizer to provide comments or commentary regarding the reading materials that would have been addressed in the meeting. The third graphical user interface may also present options for the meeting organizer and/or participants to highlight or comment on potential action items that require assignment and completion. After receiving the comments from the meeting organizer and/or participants via entry using the graphical user interface, the comments regarding the meeting may be distributed to the other participants via the third graphical user interface.

In block 272, the resource management system 320 may transmit the third graphical user interface to the one or more user devices for display. The third graphical user interface may be generally similar to the graphical user interface described in block 260 and may be an email or part of a calendar or time management software.

FIG. 3 is a block diagram of an example resource management system 320 used to manage computing and personnel resources according to an example implementation of the disclosed technology. According to some embodiments, the user device 402 and web server 410, as depicted in FIG. 4 and described below, may have a similar structure and components that are similar to those described with respect to resource management system 320 shown in FIG. 3. As shown, the resource management system 320 may include a processor 310, an input/output (I/O) device 370, a memory 330 containing an operating system (OS) 340 and a program 350. In certain example implementations, the resource management system 320 may be a single server or may be configured as a distributed computer system including multiple servers or computers that interoperate to perform one or more of the processes and functionalities associated with the disclosed embodiments. In some embodiments resource management system 320 may be one or more servers from a serverless or scaling server system. In some embodiments, the resource management system 320 may further include a peripheral interface, a transceiver, a mobile network interface in communication with the processor 310, a bus configured to facilitate communication between the various components of the resource management system 320, and a power source configured to power one or more components of the resource management system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the resource management system 320 may include one or more storage devices configured to store information used by the processor 310 (or other components) to perform certain functions related to the disclosed embodiments. In one example, the resource management system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The resource management system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the resource management system 320 may include the memory 330 that may include one or more programs 350 to perform one or more functions of the disclosed embodiments. For example, in some embodiments, the resource management system 320 may additionally manage dialogue and/or other interactions with the customer via a program 350.

The processor 310 may execute one or more programs 350 located remotely from the resource management system 320. For example, the resource management system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a resource management system database 360 for storing related data to enable the resource management system 320 to perform one or more of the processes and functionalities associated with the disclosed embodiments.

The resource management system database 360 may include stored data relating to status data (e.g., average session duration data, location data, idle time between sessions, and/or average idle time between sessions) and historical status data. According to some embodiments, the functions provided by the resource management system database 360 may also be provided by a database that is external to the resource management system 320, such as the database 416 as shown in FIG. 4.

The resource management system 320 may also be communicatively connected to one or more memory devices (e.g., databases) locally or through a network. The remote memory devices may be configured to store information and may be accessed and/or managed by the resource management system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The resource management system 320 may also include one or more I/O devices 370 that may comprise one or more interfaces for receiving signals or input from devices and providing signals or output to one or more devices that allow data to be received and/or transmitted by the resource management system 320. For example, the resource management system 320 may include interface components, which may provide interfaces to one or more input devices, such as one or more keyboards, mouse devices, touch screens, track pads, trackballs, scroll wheels, digital cameras, microphones, sensors, and the like, that enable the resource management system 320 to receive data from a user (such as, for example, via the user device 402).

In examples of the disclosed technology, the resource management system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The resource management system 320 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The resource management system 320 may be configured to adjust model parameters during training. Model parameters may include weights, coefficients, offsets, or the like. Training may be supervised or unsupervised.

The resource management system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The resource management system 320 may be configured to optimize statistical models using known optimization techniques.

Furthermore, the resource management system 320 may include programs configured to retrieve, store, and/or analyze properties of data models and datasets. For example, resource management system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The resource management system 320 may include algorithms to determine a data type, key-value pairs, row-column data structure, statistical distributions of information such as keys or values, or other property of a data schema may be configured to return a statistical profile of a dataset (e.g., using a data-profiling model). The resource management system 320 may be configured to implement univariate and multivariate statistical methods. The resource management system 320 may include a regression model, a Bayesian model, a statistical model, a linear discriminant analysis model, or other classification model configured to determine one or more descriptive metrics of a dataset. For example, resource management system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The resource management system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, resource management system 320 may be configured to generate a similarity metric representing a measure of similarity between data in a dataset. A similarity metric may be based on a correlation, covariance matrix, a variance, a frequency of overlapping values, or other measure of statistical similarity.

The resource management system 320 may be configured to generate a similarity metric based on data model output, including data model output representing a property of the data model. For example, resource management system 320 may be configured to generate a similarity metric based on activation function values, embedding layer structure and/or outputs, convolution results, entropy, loss functions, model training data, or other data model output). For example, a synthetic data model may produce first data model output based on a first dataset and produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

While the resource management system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the resource management system 320 may include a greater or lesser number of components than those illustrated.

FIG. 4 is a block diagram of an example system that may be used to view and interact with data system 408, according to an example implementation of the disclosed technology. The components and arrangements shown in FIG. 4 are not intended to limit the disclosed embodiments as the components used to implement the disclosed processes and features may vary. As shown, data system 408 may interact with a user device 402 via a network 406. In certain example implementations, the data system 408 may include a local network 412, a resource management system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the data system 408. In some embodiments, the user device 402 may include or incorporate electronic communication devices for hearing or vision impaired users.

Users may include individuals such as, for example, employees or third-party contractors of an entity associated with an organization, such as individuals who have obtained, will work for an entity associated with the data system 408. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The resource management system 320 may include programs (scripts, functions, algorithms) to configure data for visualizations and provide visualizations of datasets and data models on the user device 402. This may include programs to generate graphs and display graphs. The resource management system 320 may include programs to generate histograms, scatter plots, time series, or the like on the user device 402. The resource management system 320 may also be configured to display properties of data models and data model training results including, for example, architecture, loss functions, cross entropy, activation function values, embedding layer structure and/or outputs, convolution results, node outputs, or the like on the user device 402.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The data system 408 may be associated with and optionally controlled by one or more entities such as a business, corporation, individual, partnership, or any other entity that provides one or more of goods, services, and consultations to individuals such as customers. In some embodiments, the data system 408 may be controlled by a third party on behalf of another business, corporation, individual, or partnership. The data system 408 may include one or more servers and computer systems for performing one or more functions associated with products and/or services that the organization provides.

Web server 410 may include a computer system configured to generate and provide one or more websites accessible to customers, as well as any other individuals involved in access system 408′s normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that are authenticated by the resource management system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the data system 408 to interact with one another and to connect to the network 406 for interacting with components in the system 400 environment. In some embodiments, the local network 412 may include an interface for communicating with or linking to the network 406. In other embodiments, certain components of the data system 408 may communicate via the network 406, without a separate local network 406.

The data system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access data system 408 using the cloud computing environment. User device 402 may be able to access data system 408 using specialized software. The cloud computing environment may eliminate the need to install specialized software on user device 402.

In accordance with certain example implementations of the disclosed technology, the data system 408 may include one or more computer systems configured to compile data from a plurality of sources such as the resource management system 320, web server 410, and/or the database 416. The resource management system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

Although the preceding description describes various functions of a web server 410, a resource management system 320, and a database 416, in some embodiments, some or all of these functions may be carried out by a single computing device.

### EXAMPLE USE CASE

The following example use case describes an example of a typical user flow pattern. This section is intended solely for explanatory purposes and not in limitation.

In one example, Scott is a meeting organizer. Scott at 4:00 PM sets up a meeting for the next business day at 10:00 AM with three other meeting participants, Jack, Trevor, and Valerie. The meeting invitation includes an agenda for the meeting and required reading. At block 202, resource management system 320, receives the meeting data regarding the meeting, including user data about Jack, Trevor, Valerie, and Scott. The resource management system 320 then calculates, at block 204, using the meeting data, a meeting score. The machine learning model used to calculate the meeting score makes several assumptions based on prior training data, specifically that: (1) the score should rise 0.4 because Jack, Trevor, and Valerie have a short amount of time to review the required reading, and the required reading is 50 pages; (2) the score should rise 0.2 because Valerie's schedule for tomorrow is very busy; (3) the score should rise 0.1 because Trevor is on Scott's team and is in nearly every meeting with Scott; and (4) the score should rise 0.1 because Jack is a department head (based on the organizational chart), and does not need to be involved with this meeting. The total score of the meeting is 0.8. At block 206, the resource management system 320 determines that the threshold meeting score based on organizational rules is 0.6. Therefore, since the meeting score of 0.8 is above 0.6, the resource management system 320 generates a graphical user interface message at block 208 to send to Scott indicating that the meeting has a score of 0.8, which is above the threshold score of 0.6. The generated graphical user interface contains several options: (1) move the meeting to at least two days later, to give participants additional time to review the required reading, which would reduce the meeting score by 0.4; (2) move the meeting to three days later, when Valerie is less busy, which would reduce the meeting score by 0.2; (3) override the suggestions, and continue to have the meeting; (4) view options for various dates showing the meeting score at various times; and (5) cancel the meeting. At block 210, the resource management system 320 transmits the graphical user interface message to Scott's smartphone, which presents the graphical user interface on a calendar mobile application by highlighting the meeting time and indicating a problem. The graphical user interface states that “the meeting does not meet corporate standard meeting score requirements” and “the following remedial actions are suggested,” listing the options. Scott reviews the graphical user interface and selects a date for the meeting one week in the future that the resource management system 320 indicates has a meeting score of 0.2 (block 212). Accordingly, the resource management system 320 notifies the meeting participants that the meeting has been moved to a different date. The resource management system 320 then uses Scott's choice to reschedule the meeting to a different day to improve the meeting score to train the first machine learning model (block 214).

In some examples, disclosed systems or methods may involve one or more of the following clauses:

Clause 1: A distributed computing system management tool comprising: one or more processors; memory in communication with the one or more processors and storing instructions that are configured to cause the system to: receive, from a plurality of distributed computing devices, first data associated with the plurality of distributed computing devices indicating work performed associated with a first work request; calculate, using a first machine learning model, a score associated with the first work request based on the first data; determine whether the score is greater than or equal to a threshold score representing work to be performed; responsive to determining that the score is greater than or equal to the threshold score: generate a first message canceling the first work request; and transmit the first message to at least one distributed computing device of the plurality of distributed computing devices.

Clause 2: The distributed computing system management tool of clause 1, wherein the memory stores further instructions that are configured to cause the system to: receive, from the at least one distributed computing device, a second message refusing to cancel the first work request; and train the first machine learning model using the second message.

Clause 3: The distributed computing system management tool of clause 1, wherein the memory stores further instructions that are configured to cause the system to: receive, from the at least one distributed computing device, a third message accepting cancellation of the first work request; and train the first machine learning model using the third message.

Clause 4: The distributed computing system management tool of clause 1, wherein the threshold score is based on an existing demand on resources.

Clause 5: The distributed computing system management tool of clause 1, wherein determining that the score is greater than or equal to the threshold score further comprises determining whether an existing work product is sufficient.

Clause 6: A meeting system comprising: one or more processors; memory in communication with the one or more processors and storing instructions that are configured to cause the meeting system to: receive, from one or more user devices associated with one or more users, meeting data regarding a meeting and user data, wherein one of the users is a meeting organizer; calculate, using content analysis by a first machine learning model, a meeting score, from the meeting data; determine whether the meeting score is greater than or equal to a meeting threshold score; responsive to determining that the meeting score is greater than or equal to the meeting threshold score: generate a message recommending the meeting be canceled; transmit the message to the meeting organizer; receive a signal from the meeting organizer indicating whether the meeting is canceled; and train the first machine learning model using the signal from the meeting organizer.

Clause 7: The meeting system of clause 6, wherein generating the message recommending the meeting be canceled is completed by a second machine learning model.

Clause 8: The meeting system of clause 6, wherein the meeting score is calculated from: analyzing a meeting agenda to determine whether the meeting requires action or discussion; determining whether background material has been available for an insufficient amount of time prior to the meeting; and analyzing the user data of the one or more user devices and determining whether the meeting would present a scheduling burden on a majority of the one or more users.

Clause 9: The meeting system of clause 8, wherein: when the meeting requires action or discussion the meeting score remains the same, and wherein when the meeting is informational the meeting score increases; when the background material has been available for an insufficient amount of time prior to the meeting, the meeting score increases; and when the meeting would present a scheduling burden on the majority of the one or more users, the meeting score increases.

Clause 10: The meeting system of clause 6, wherein the meeting score is calculated from: analyzing meeting content to determine which of the one or more users are meeting presenters; determining whether meeting presenters work frequently together; and responsive to determining that the meeting presenters work frequently together: increasing the meeting score.

Clause 11: The meeting system of clause 10, wherein determining whether the meeting presenters work frequently together comprises comparing division names associated with the meeting presenters.

Clause 12: The meeting system of clause 10, wherein determining whether the meeting presenters work frequently together comprises using a chart to determine a distance between the meeting presenters.

Clause 13: The meeting system of clause 12, wherein when the distance between the meeting presenters on the chart is greater than a threshold distance, the meeting score remains the same, and wherein when the distance between the meeting presenters on the chart is less than the threshold distance on the chart, the meeting score increases.

Clause 14: The meeting system of clause 12, whether when the distance between the meeting presenters on the chart is less than a threshold distance, the meeting score remains the same, and wherein when the distance between the meeting presenters on the chart is greater than the threshold distance on the chart, the meeting score increases.

Clause 15: The meeting system of clause 6, wherein the memory stores further instructions that are configured to cause the meeting system to: calculate one or more alternate meeting scores for one or more alternate dates, and wherein: generating the message with a cancellation suggestion further comprising the one or more alternate dates with the one or more alternate meeting scores.

Clause 16: The meeting system of clause 6, wherein the memory stores further instructions that are configured to cause the meeting system to: generate, using content analysis, a first user score for a first user, from the user data and the meeting data; determine whether the first user score is greater than or equal to a first user threshold score; and responsive to determining that the first user score is greater than or equal to the first user threshold score: cancel the meeting for the first user; responsive to canceling the meeting for the first user: recalculate the meeting score; generate a summary of the meeting from the meeting data; and transmit the summary of the meeting to the first user.

Clause 17: The meeting system of clause 6, wherein the memory stores further instructions that are configured to cause the meeting system to: transmit, to the one or more user devices, a request for an evaluation of the meeting; receive, from the one or more user devices, the evaluation of the meeting; and responsive to the evaluation of the meeting, change the meeting threshold score.

Clause 18: A meeting system comprising: one or more processors; memory in communication with the one or more processors and storing instructions that are configured to cause the meeting system to: receive, from one or more user devices associated with one or more users, meeting data regarding a meeting and user data, wherein one of the users is a meeting organizer; calculate, using content analysis by a first machine learning model, a meeting score, from the meeting data; determine whether the meeting score is greater than or equal to a meeting threshold score; responsive to determining that the meeting score is greater than or equal to the meeting threshold score: generate a first graphical user interface for polling the one or more users regarding whether the meeting should be held; transmit the first graphical user interface to the one or more user devices for display; receive results from the one or more user devices regarding whether the meeting should be held; determine whether the meeting should be held based on an organizational policy; responsive to determining that the meeting should be held: generate a second graphical user interface notifying the one or more users that the meeting will be held; transmit the second graphical user interface to the one or more user devices for display; responsive to determining that the meeting should not be held: generate a third graphical user interface notifying the one or more users that the meeting will not be held; and transmit the third graphical user interface to the one or more user devices for display.

Clause 19: The meeting system of clause 18, wherein: determining whether the meeting should be held based on the organization policy further comprises determining whether a majority of users believe that meeting needs to be held; and the memory stores further instructions that are configured to cause the meeting system to: train the first machine learning model based on an outcome of the poll by the users.

Clause 20: The meeting system of clause 18, wherein: determining whether the meeting should be held based on the organization policy further comprises determining whether the meeting organizer chose that the meeting should be held in the poll; and the memory stores further instructions that are configured to cause the meeting system to: train the first machine learning model based on a choice of the meeting organizer in the poll.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A distributed computing system management tool comprising:
one or more processors;
memory in communication with the one or more processors and storing instructions that are configured to cause the system to:
receive, from a plurality of distributed computing devices, first data associated with the plurality of distributed computing devices indicating work performed associated with a first work request;
calculate, using a first machine learning model, a score associated with the first work request based on the first data;
determine whether the score is greater than or equal to a threshold score representing work to be performed;
responsive to determining that the score is greater than or equal to the threshold score:
generate a first message canceling the first work request; and
transmit the first message to at least one distributed computing device of the plurality of distributed computing devices.

2. The distributed computing system management tool of claim 1, wherein the memory stores further instructions that are configured to cause the system to:
receive, from the at least one distributed computing device, a second message refusing to cancel the first work request; and
train the first machine learning model using the second message.

3. The distributed computing system management tool of claim 1, wherein the memory stores further instructions that are configured to cause the system to:
receive, from the at least one distributed computing device, a third message accepting cancellation of the first work request; and
train the first machine learning model using the third message.

4. The distributed computing system management tool of claim 1, wherein the threshold score is based on an existing demand on resources.

5. The distributed computing system management tool of claim 1, wherein determining that the score is greater than or equal to the threshold score further comprises determining whether an existing work product is sufficient.

6. A meeting system comprising:
one or more processors;
memory in communication with the one or more processors and storing instructions that are configured to cause the meeting system to:
receive, from one or more user devices associated with one or more users, meeting data regarding a meeting and user data, wherein one of the users is a meeting organizer;
calculate, using content analysis by a first machine learning model, a meeting score, from the meeting data;
determine whether the meeting score is greater than or equal to a meeting threshold score;
responsive to determining that the meeting score is greater than or equal to the meeting threshold score:
generate a message recommending the meeting be canceled;
transmit the message to the meeting organizer;
receive a signal from the meeting organizer indicating whether the meeting is canceled; and
train the first machine learning model using the signal from the meeting organizer.

7. The meeting system of claim 6, wherein generating the message recommending the meeting be canceled is completed by a second machine learning model.

8. The meeting system of claim 6, wherein the meeting score is calculated from:
analyzing a meeting agenda to determine whether the meeting requires action or discussion;
determining whether background material has been available for an insufficient amount of time prior to the meeting; and
analyzing the user data of the one or more user devices and determining whether the meeting would present a scheduling burden on a majority of the one or more users.

9. The meeting system of claim 8, wherein:
when the meeting requires action or discussion the meeting score remains the same, and wherein when the meeting is informational the meeting score increases;
when the background material has been available for an insufficient amount of time prior to the meeting, the meeting score increases; and
when the meeting would present a scheduling burden on the majority of the one or more users, the meeting score increases.

10. The meeting system of claim 6, wherein the meeting score is calculated from:
analyzing meeting content to determine which of the one or more users are meeting presenters;
determining whether meeting presenters work frequently together; and
responsive to determining that the meeting presenters work frequently together:
increasing the meeting score.

11. The meeting system of claim 10, wherein determining whether the meeting presenters work frequently together comprises comparing division names associated with the meeting presenters.

12. The meeting system of claim 10, wherein determining whether the meeting presenters work frequently together comprises using a chart to determine a distance between the meeting presenters.

13. The meeting system of claim 12, wherein when the distance between the meeting presenters on the chart is greater than a threshold distance, the meeting score remains the same, and wherein when the distance between the meeting presenters on the chart is less than the threshold distance on the chart, the meeting score increases.

14. The meeting system of claim 12, whether when the distance between the meeting presenters on the chart is less than a threshold distance, the meeting score remains the same, and wherein when the distance between the meeting presenters on the chart is greater than the threshold distance on the chart, the meeting score increases.

15. The meeting system of claim 6, wherein the memory stores further instructions that are configured to cause the meeting system to:
calculate one or more alternate meeting scores for one or more alternate dates, and wherein:
generating the message with a cancellation suggestion further comprising the one or more alternate dates with the one or more alternate meeting scores.

16. The meeting system of claim 6, wherein the memory stores further instructions that are configured to cause the meeting system to:
generate, using content analysis, a first user score for a first user, from the user data and the meeting data;
determine whether the first user score is greater than or equal to a first user threshold score; and
responsive to determining that the first user score is greater than or equal to the first user threshold score:
cancel the meeting for the first user;
responsive to canceling the meeting for the first user:
recalculate the meeting score;
generate a summary of the meeting from the meeting data; and
transmit the summary of the meeting to the first user.

17. The meeting system of claim 6, wherein the memory stores further instructions that are configured to cause the meeting system to:
transmit, to the one or more user devices, a request for an evaluation of the meeting;
receive, from the one or more user devices, the evaluation of the meeting; and
responsive to the evaluation of the meeting, change the meeting threshold score.

18. A meeting system comprising:
one or more processors;
memory in communication with the one or more processors and storing instructions that are configured to cause the meeting system to:
receive, from one or more user devices associated with one or more users, meeting data regarding a meeting and user data, wherein one of the users is a meeting organizer;
calculate, using content analysis by a first machine learning model, a meeting score, from the meeting data;
determine whether the meeting score is greater than or equal to a meeting threshold score;
responsive to determining that the meeting score is greater than or equal to the meeting threshold score:
generate a first graphical user interface for polling the one or more users regarding whether the meeting should be held;
transmit the first graphical user interface to the one or more user devices for display;
receive results from the one or more user devices regarding whether the meeting should be held;
determine whether the meeting should be held based on an organizational policy;
responsive to determining that the meeting should be held:
generate a second graphical user interface notifying the one or more users that the meeting will be held;
transmit the second graphical user interface to the one or more user devices for display;
responsive to determining that the meeting should not be held:
generate a third graphical user interface notifying the one or more users that the meeting will not be held; and
transmit the third graphical user interface to the one or more user devices for display.

19. The meeting system of claim 18, wherein:
determining whether the meeting should be held based on the organization policy further comprises determining whether a majority of users believe that meeting needs to be held; and
the memory stores further instructions that are configured to cause the meeting system to:
train the first machine learning model based on an outcome of the poll by the users.

20. The meeting system of claim 18, wherein:
determining whether the meeting should be held based on the organization policy further comprises determining whether the meeting organizer chose that the meeting should be held in the poll; and
the memory stores further instructions that are configured to cause the meeting system to:
train the first machine learning model based on a choice of the meeting organizer in the poll.
